(19) United States
(12) Patent Application Publication
(10) Pub. No.: US 2009/0185965 A1
(43) Pub. Date: Jul. 23, 2009

(54) Method for separating zirconium and hafnium

(76) Inventors: Laurence Delons, Saint Genis Laval (FR); Stéphane Lagarde, St Pierre De Mesage (FR); Ludovic Poriel, Lyon (FR); Marc Lemaire, Villeurbanne (FR); Alain Favre-Reguillon, Villeurbanne (FR); Stéphane Pellet-Rostaing, Villeurbanne (FR)

Correspondence Address: Davidson, Davidson & Kappel, LLC, 485 7th Avenue, 14th Floor, New York, NY, 10018, US

(21) Appl. No.: 11/665,526

(22) PCT Filed: Oct. 7, 2005
(86) PCT No.: PCT/FR2005/002481

§ 371 Date: Dec. 29, 2008

(30) Foreign Application Priority Data
Oct. 11, 2004 (FR) 0410714

(51) Int. Cl. C01G 25/02; C01G 27/02

(52) U.S. Cl. 423/70

(57) ABSTRACT

A method for separating zirconium and hafnium from a mixture of ZrCl₄ and HfCl₄ containing 3 wt. % or less of Hf based on Zr+Hf, the method includes the following steps: 1) hydrolyzing a mixture of ZrCl₄ and HfCl₄ in an aqueous solution of strong inorganic acid, so as to form an aqueous solution having 7 to 12 moles of acid per liter; 2) passing the solution obtained at step 1) in an anion exchanging resin; 3) optionally eluting a fraction of said aqueous solution having 7 to 12 moles of acid per liter, enriched in hafnium; 4) removing the resin of the acid solution containing Zr and Hf; 5) passing in the resin an aqueous solution to detach the zirconium compounds fixed to the resin, and recovering a zirconium-enriched fraction.

### FIELD OF THE INVENTION

The present invention relates to a method for separating and purifying the zirconium contained in mixtures containing hafnium and zirconium. It also relates to a method for separating and purifying the hafnium contained in these mixtures.

### BACKGROUND OF THE INVENTION

The mineral zircon contains zirconium, as the major constituent, and hafnium (generally from 1 to 3% by weight). For use in the nuclear industry, after carbochlorination of the mineral, the zirconium must be processed to remove as much as possible of the hafnium, which therefore appears in the residual fractions of the zirconium purification processes. Various techniques have been developed. They include multiple crystallization of potassium and zirconium fluorides, liquid-liquid extraction methods, and extractive distillation in fused salts. Sometimes the hafnium is also recovered from the subproducts of zirconium purification. At the present time there is no truly efficient method for the recovery and purification of hafnium.

None of the currently used methods for separating zirconium and hafnium is free of drawbacks. For example, conventional liquid-liquid extraction methods use organic solvents of the MIBK and NH₄SCN types. The hafniated zirconium tetrachloride resulting from the initial carbochlorination step is hydrolysed; this yields the oxychlorides of Zr and Hf, which are then separated in numerous columns after the addition of MIBK (methyl isobutyl ketone) and NH₄SCN (ammonium thiocyanate). The oxychlorides are then precipitated in the hydroxide form by means of ammonia for example, then calcined to produce zirconium, ZrO₂ (and HfO₂). These oxides are carbochlorinated again, to produce zirconium tetrachloride, ZrCl₄ (and HfCl₄). These liquid-liquid methods generate a large amount of effluent, including gaseous effluent, requiring treatment in high-temperature furnaces, and liquid effluent, containing substances which are dangerous to humans and the environment. In particular, the MIBK solvent is volatile and highly explosive.

One of the most efficient methods used at present for zirconium purification is known as the method of fused salt separation, or extractive distillation in fused salts (FR-A-2 250 707 and FR-A-2 629 360). This method uses a distillation column with a plurality of plates, each holding a layer of fused salts. A mixture of ZrCl₄ and HfCl₄, produced by carbochlorination of the mineral zircon, is introduced into the column in the gaseous state. A ZrCl₄ fraction is recovered in the solvent phase at the foot of the column, while a residual HfCl₄-enriched fraction is carried to the head of the column in the vapour phase. This residual fraction can thus contain, for example, approximately 70% ZrCl₄ and 30% HfCl₄. An industrial plant operating according to this principle can be reconditioned to reprocess this residual fraction and recover the hafnium, although this requires non-continuous operation of the plant.

Finally, the requirement for a method of purifying large quantities of very pure hafnium is underlined by the demand of certain industries for hafnium of increasing purity.

### SUMMARY OF THE INVENTION

One object of the invention is therefore to propose a new industrial method for continuously and efficiently separating and purifying zirconium from a mixture of zirconium and hafnium.

Another object of the invention is to propose an industrial method for continuously and efficiently separating and purifying both hafnium and zirconium.

Another object of the invention is to propose a method of this kind which is compatible with the present techniques of carbochlorination of the mineral zircon and production of metallic Hf and Zr, so that it can be integrated into a separation and purification system starting from the mineral zircon.

Another object of the invention is to propose a method which is more environmentally friendly and less dangerous for the user than the conventional liquid-liquid extraction methods.

These objects, together with others, are achieved according to the invention with the aid of a method for separating zirconium from hafnium in a mixture of ZrCl₄ and HfCl₄ containing 3% Hf by weight expressed with respect to Hf+Zr (% Hf/Hf+Zr) or less. The method comprises the following steps:

(1) hydrolysing a mixture of ZrCl₄ and HfCl₄ in an aqueous solution of strong inorganic acid, to form an aqueous acid solution having 7 to 12 moles of acid per liter;

(2) passing the solution obtained in step (1) through an anion exchange resin;

(3) possibly, but preferably, eluting a hafnium-enriched fraction of the aqueous acid solution;

(4) removing the acid solution containing Zr and Hf from the resin; and then

(5) passing an aqueous solution through the resin in order to release the zirconium compounds fixed to the resin, and recover a zirconium-enriched fraction.

It should be noted that, throughout the description and claims, the terms “comprises”, “comprising”, and the like, derived from the verb “to comprise”, have the meaning usually attributed under the law of the United States of America; these terms mean that other characteristics may be added; they have the same meaning as “to include”, “including”, etc.

The method is applied to a mixture of ZrCl₄ and HfCl₄ formed by the carbochlorination of the mineral zircon. Such a mixture generally comprises 1 to 3% of Hf/Hf+Zr by weight.

Preferably, the mixture of ZrCl₄ and HfCl₄ used in step (1) is in solid form, and particularly in the form of powder.

According to a preferred aspect, the resin used in step (2) is soaked (conditioned or preconditioned) with an aqueous solution of strong inorganic acid having 7 to 12 moles of acid per liter. A preferred procedure consists in conditioning the resin with a solution comprising the same acid as in step (1) and having an acid concentration similar or identical to the solution obtained in this step.

Without being bound to the theory, it is thought that the solution known as the feed solution obtained in step (1) contains zirconium compounds in anionic form, and hafnium compounds, generally in non-ionic form, and that, during passage through the resin, the predominantly zirconium-based anions are retained by the resin, by an ion exchange process, to the extent that, until a certain proportion of the resin groups is saturated by the zirconium-based ions, the eluate leaving the resin predominantly contains hafnium compounds.

According to a particularly advantageous aspect, in step (3) the feed solution is passed through in such a way as to produce a hafnium-rich eluate, which is recovered.

The degree of purity or enrichment of hafnium depends on the column height and the flow rate of the feed solution. It can vary according to the instant of collecting. For example, it is possible to obtain a metallic zirconium content less than or equal to 100 molar ppm, expressed with respect to the metallic hafnium, less than or equal to 50 ppm, or less than or equal to 30 ppm, e.g. approximately 20 molar ppm of metallic Zr with respect to metallic Hf.

This phase of elution of the hafnium-rich fraction can be monitored during the purification process, in which case samples of eluate are taken together with a control relating to their content of zirconium and/or hafnium compounds. The eluates can be analysed, for example, by ICP-AES (inductively coupled plasma—atomic emission spectroscopy) to determine the purity of the hafnium or zirconium in the fractions, which in particular makes it possible to select the fractions if required. Further information is given in the detailed description. It is also possible to provide a standardized operating procedure.

When a certain degree of saturation of the resin groups has been reached, the eluate leaving the resin tends to match the feed solution overall.

In step (4), the resin is cleaned to eliminate the zirconium and hafnium which are present interstitially in the resin without being bound to it.

In a first embodiment for this step (4), the liquid content of the resin is removed, for example by gravity or by flushing with air or gas (e.g. nitrogen).

In a second embodiment for this step (4), a rinsing solution is circulated in the resin; this has the characteristic of not releasing the zirconium compounds bound to the resin by ion interaction. It is preferable to use a strong inorganic acid solution having 7 to 12 moles per liter, and having a number of moles of acid per liter greater than or substantially identical to the feed solution formed in step (1). The phrase “substantially identical” denotes that the acid concentration can vary with respect to step (1), possibly towards lower values, while remaining within such limits that there is no substantial release of the zirconium compounds bound to the resin by ion interaction. It is preferable to use the same acid (e.g. HCl) as in step (1). It is also preferable to use the same acid concentration.

In a third embodiment for the step (4), the resin is initially emptied, e.g. by gravity or by flushing, after which it is rinsed as described above.

According to a preferred aspect, step (4) is carried out immediately after the recovery of the hafnium-rich fraction or the final hafnium-rich fraction. By monitoring the elution phase by analysis of the eluates as mentioned above, it is possible to determine this moment when there is no use in continuing the feed with the zirconium and hafnium mixture.

The solution resulting from step (4) can be recycled to step (1) with the addition of the feed solution, provided that the necessary adjustments are made to maintain the acidity mentioned in step (1).

When the recovery of hafnium is not required, step (3) can be omitted and step (4) can begin as soon as a sufficient level of saturation of the resin with Zr has been reached.

After step (4), in step (5) the resin is washed with water or with an equivalent aqueous solution to release the zirconium compounds bound to the resin by ion interaction, and to recover an aqueous solution rich in zirconium or containing purified zirconium.

The phrase “equivalent aqueous solution” denotes an aqueous solution capable of releasing the zirconium compound, for example an acid solution having a strength below that of the solution used in the preceding steps, e.g. an aqueous solution having 0 to 7 moles, more particularly 0 to 6 moles, of acid per liter, chosen to be below the level of the solution used previously.

In a particular embodiment for this step (5), a gradual release is carried out by means of aqueous solutions having decreasing acid concentrations. Water is preferably used at the end of the process. For example, at least a first release is carried out by means of a suitable aqueous acid solution (for example HCl 0.1 to 7, or particularly 0.1 to 6, moles per liter), followed by a final release with water.

The release solution or solutions cause the release of the metallic compounds fixed to the resin, and this step therefore makes it possible to recover one or more fractions rich in zirconium or containing purified zirconium. Thus, for example, it is possible to recover one or more fractions having metallic Hf contents of less than or equal to 500, 100, 80, 50 or 20 ppm by weight, expressed with respect to Zr+Hf.

According to another embodiment of the invention, the zirconium-rich fraction is subjected to the sequence of steps (1) to (5) at least once more, either on its own, or in addition to a feed solution as defined above. Preferably, the said fraction is processed in such a way as to produce an aqueous acid solution having 7 to 12 moles of acid per liter.

The strong inorganic acid used in the different steps is defined as having a pKa in range from −12 to 4 with respect to water. It is preferably chosen from HCl and H₂SO₄. In a preferred embodiment, the acid solution formed in step (1) and the acid solutions used in the other steps contain 7.5 to 9.5 moles of acid per liter. Preferably, the acid solutions used in the different steps are similar or identical. In a preferred embodiment of the invention, aqueous solutions of HCl are used in all the steps, particularly solutions containing 7.5 to 9.5 moles of acid per liter.

The resin used has a solid phase which resists the acid solutions used when the method is applied. It is convenient to use any usual organic resin having cationic functional groups, and whose counter-ion (anion) is able to be exchanged with the anionic compounds of the zirconium present in the acid feed solution according to the invention. These groups are advantageously amine, ammonium and/or azine groups.

The organic resins can be strong or weak anionic resins. Their functional groups are preferably represented by, or comprise:
primary, secondary or tertiary amines, the substituents other than H being preferably chosen from linear or branched C₁ to C₆ alkyl, phenyl or alkylphenyl with alkyl as defined above, linear or branched C₁ to C₆ hydroxyalkyl, and combinations; in a preferred embodiment, the substituents other than H are alkyls;
quaternary ammoniums in which the substituents can be chosen from linear, branched or cyclic C₁ to C₆ alkyl, phenyl, alkylphenyl with alkyl as defined above, linear or branched C₁ to C₆ hydroxyalkyl, and combinations; in a preferred embodiment, the substituents are alkyls;
azines: nitrogenous heterocyclic compounds such as pyridine, 1,2-diazabenzene (or pyridazine), 1,3-diazabenzene (or pyrimidine) and 1,4-diazabenzene (or pyrazine), 1,2,3-triazabenzene (or 1,2,3-triazine), 1,2,4-triazabenzene (or 1,2,4-triazine), 1,3,5-triazabenzene (or 1,3,5-triazine), and the corresponding quaternary ammonium analogues obtained by substitution of the nitrogens by linear or branched C₁-C₆ alkyl groups.

It is preferable to use resins whose counter-ion is of the same nature as the acid used for the acid solution. With HCl, it is preferable to use these resins in the form of chlorides (counter-ion Cl⁻). With sulphuric acid, it is preferable to use these resins in the form of sulphates (counter-ion SO₄⁼).

In a first embodiment, the solid phase consists of resin in a particular form, e.g. in the form of more or less spherical beads, with an appropriate mean particle size or mean diameter, generally in the range from 30 to 800 micrometers. Persons skilled in the art will have no difficulty in choosing the polymer or copolymer to form the solid phase, its degree of cross-linking and the particle size. The resins used in the examples showed that mean particle sizes in the range from 100 to 700 micrometers, preferably from 200 to 600 micrometers, were very suitable.

The polymers and copolymers which can be used include those based on styrene, acrylate and methacrylates. According to the invention, it is therefore possible to use resins of the polystyrene, polyacrylate, and polymethacrylate types, and polyacrylate/polymethacrylate copolymers. Polystyrene-based resins are a preferred option.

In a second embodiment, the resin has mineral particles functionalized by functions similar to those described for organic resins, particularly amines, quaternary ammoniums and azines (see above). The mineral particles making up such a resin are, for example, particles of silica, zeolites, aluminosilicates, and mixtures of these.

In a third embodiment, the resin has mineral particles (e.g. silica, zeolites, aluminosilicates, and mixtures of these), coated by or carrying on their surfaces a functionalized organic polymer or copolymer as described above.

The capacity of the resin to fix metallic ions, expressed in milliequivalents per mL of wet resin, is preferably greater than 0.5, and more preferably greater than or equal to 1.

The method according to the invention does not require a complex plant. It can thus be applied in a column or in any vessel (hereafter termed “column or similar”), having a volume suitable for the volume of resin used, this volume being itself suitable for the solution to be processed, so that the zirconium and if necessary the hafnium can be purified with the use of the same column or similar.

One operating parameter is the flow rate of the acid solution in the column or similar. The flow rate must not be too fast to allow the ion exchange to take place as required. However, it must be sufficient to ensure that the method can be applied with suitable rapidity, and if necessary must promote rapid concentration of hafnium in the eluate at step (3) as soon as the resin is saturated with hafnium compounds. This parameter can therefore be determined easily by simple routine tests and analysis of the eluates, by ICP-AES for example. It is also possible to provide a standardized method.

In the present description, the concept of volume relates to the volume of resin used. Thus, if the expression “two volumes of solution” is used, this means that we use a volume of solution representing twice the volume of the resin used.

After rinsing with water and/or with a weakened acid solution in step (5), the resin can be re-used. In a preferred embodiment, the resin is reconditioned by the acid solution, making it possible to eliminate the water or equivalent aqueous solution and bring the resin into optimal condition for a further separation and purification cycle.

Before this reconditioning, the water or equivalent aqueous solution can be eliminated in advance by gravity (drainage) or by flushing with air or gas.

It is possible to dispense with the conditioning of the resin in step (2), although this is not preferred. In this case, before the resin is re-used, the water or equivalent aqueous solution resulting from step (5) can possibly be eliminated by gravity (drainage) or by flushing with air or gas.

The method according to the invention is distinctive in that the ion exchange and the release and/or washing are carried out without using alkaline media. The method has proved to be advantageous for the integrity and preservation of the resin, since the resin is not exposed to changes of pH from acid to alkaline.

In the operating conditions of the method according to the invention, the temperature is not a critical parameter, and it is therefore advantageously possible to operate at a temperature in the range from 0 to 40° C., preferably from 15 to 25° C.

Another advantage of the invention is that the method is not sensitive to the presence of ions found naturally in water (alkaline and alkaline earth ions).

In an industrial zirconium purification plant, according to a preferred embodiment, a plurality of columns or similar are installed, and are positioned in parallel and fed in sequence, in such a way that there is always a column or similar ready for use, conditioned or reconditioned, ready to receive the solution to be processed resulting from step (1). It is thus possible to carry out continuous purification of a solution resulting from the initial carbochlorination of the mineral zircon. The operations of zirconium and/or hafnium purification, cleaning, e.g. rinsing with acid solution, release with the aqueous solution, and reconditioning of the resin are carried out as described above.

The plant can operate by gravity, but it is preferable to force the solutions through the columns or similar, and more preferably the column or similar are fed from below and the solutions are circulated from the bottom to the top.

The method requires a smaller amount of equipment, namely one or more columns or similar and injection and/or extraction pump(s).

The volume of resin, the dimensions of the columns or similar, the size of the resin particles, their nature and the flow rate of the solutions are operating parameters which enable persons skilled in the art to optimize a plant according to the quantities of metal to be processed.

The pure zirconium or hafnium compounds which are obtained are in the form of oxychlorides, ZrOCl₂ and HfOCl₂. Methods for producing metallic zirconium or metallic hafnium from these oxychlorides exist, and are known to persons skilled in the art. Thus the oxychlorides can be converted to hydroxides (Zr(OH)₄ or Hf(OH)₄), dehydrated to ZrO₂ and HfO₂, then carbochlorinated and reduced by the Kroll method to recover metallic Zr and Hf (Nouveau Traité de Chimie Minérale, Paul Pascal, Vol. IX, pp. 254-269). In another method, the oxychloride solution is evaporated, then carbochlorinated and reduced to the metal.

### DETAILED DESCRIPTION

The invention will now be described more fully, with the aid of the examples and embodiments described below, provided by way of example and without restrictive intent.

1. Experimental part

1.1. Products used
1.1.1. Source of zirconium and hafnium

The zirconium/hafnium separation studies were carried out using zirconium and hafnium tetrachlorides with weight ratios of 97.5/2.5 (as obtained after carbochlorination of mineral zircon).
1.1.2. Resins

The resins used for the solid-liquid extraction of zirconium and hafnium are resins of the quaternary ammonium type and azines:

Dowex® 1×8 resin is a trimethylated ammonium chloride grafted on to a styrene-DVB matrix, with a functionalization rate of 3.5 meq/g of dry resin. Dowex® 1×8 resin is supplied by Aldrich. Particle size: 150-300 micrometers.

Reillex™ HPQ resin is an N-methyl poly(4-vinylpyridine). Its maximum capacity is 4 meq/g of dry resin. Its water content is 67-75%. Particle size: 250-595 micrometers.

Structures of the resins used:

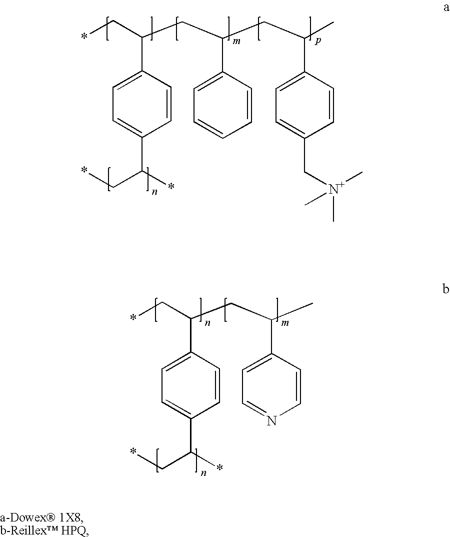

1.1.3. Solvent

Hydrochloric acid, 37% by weight, in water

1.2. ICP-AES analysis

The aqueous phases were analysed by ICP-AES (inductively coupled plasma—atomic emission spectroscopy). The measurements were made with a Spectro D spectrophotometer, made by Spectro. The zirconium was measured at a wavelength of 339.198 nm and the hafnium was measured at 282.022 nm. The uncertainty of these measurements was ±0.2 mg/L.

1.3. Definitions of the constants used for solid-liquid extraction

Ci: initial metal concentration (mg/L)

Cf: final metal concentration (mg/L)

Vol_{aq}: volume of the aqueous phase in contact with the resin

m: mass of resin

E: extraction (%)

D: distribution coefficient (mL/g)

D(Zr): distribution coefficient of the zirconium (mL/g)

D(Hf): distribution coefficient of the hafnium (mL/g).

The extraction percentage is defined by the following formula:

$$E = \frac{( Ci - Cf )}{Ci} \times 100$$

The extraction properties of the complexing agents used with respect to the zirconium and the hafnium is evaluated by comparing the distribution coefficients. This constant is determined experimentally by the measurement of the aqueous phase before and after extraction.

$$D = [ \frac{Ci - Cf}{Cf} ] \times [ \frac{{Vol}_{aq}}{m} ]$$

The selectivity S(Zr/Hf) for zirconium with respect to hafnium is defined as the ratio of the distribution coefficients D(Zr) and D(Hf).

$$S ( Zr \text{/} Hf ) = \frac{D ( Zr )}{D ( Hf )}$$

1.4. Experiments
1.4.1. Preparation of the aqueous phase

Aqueous solutions of zirconium at 3500-4000 mg/L are prepared by magnetic stirring, the zirconium tetrachloride and hafnium tetrachloride powder (with a ratio of 97.5/2.5% by weight) being dissolved in hydrochloric acid solutions whose concentrations vary from 0 to 12 mol/L.
1.4.2. Procedure

The zirconium and hafnium are separated by solid-liquid extraction with resins. The flasks are stirred with a Vibramax 100 horizontal mechanical stirrer (made by Bioblock Scientific) for 10 minutes. The experiments are carried out at ambient temperature. The aqueous phases are then measured by ICP-AES. The extraction percentages and the distribution coefficients of the zirconium and hafnium can be determined. Re-extraction is carried out with distilled water. The measurement of this, aqueous phase by ICP-AES is used to calculate the re-extraction percentage for Zr and Hf. The aqueous phases are then stirred with the extractant (resin) to perform the extraction. The HCl concentration is monitored in all the solutions by acid-basic determination of the aqueous phase by 0.5 mol/L soda in the presence of phenolphthalein.
1.4.3. Results

The experiments in the extraction of Zr/Hf from a (97.5/2.5) mixture as a function of the HCl concentration were carried out using Reillex® HPQ and Dowex® 1×8 resins.

TABLE 1
Effect of HCl concentration on Zr/Hf separation
with Dowex ® 1X8 resin:

| [HCl] | extraction | extraction | D (Zr) | D (Hf) | |
|---|---|---|---|---|---|
| mol/L | Zr (%) | Hf (%) | (mL/g) | (mL/g) | S(Zr/Hf) |
| H₂O | 0 | 0 | 0 | 0 | ND |
| 5 | 1.6 | 2.1 | 0.2 | 0.2 | ND |
| 8.5 | 6.2 | 2.1 | 0.6 | 0.2 | 3 |
| 9.5 | 25.8 | 5.3 | 3.5 | 0.6 | 5.8 |
| 12 | 35.6 | 21.7 | 5.5 | 2.8 | 2 |

[Zr] = 3500-4000 mg/L; Dowex ® 1X8 resin: m = 1 g; vol_{aq} = 10 mL; stirring = 10 min.; ambient temperature.
ND: values not determined because the extraction percentage was too low.

TABLE 21
Effect of HCl concentration on Zr/Hf separation
with Reillex ™ HPQ resin

| [HCl] | extraction | extraction | D (Zr) | D (Hf) | |
|---|---|---|---|---|---|
| mol/L | Zr (%) | Hf (%) | (mL/g) | (mL/g) | S(Zr/Hf) |
| H₂O | 2.9 | 1.9 | 0.3 | 0.2 | ND |
| 7 | 8.9 | 1.1 | 0.9 | 0.1 | 9 |
| 8.5 | 57.2 | 11.6 | 13.2 | 1.3 | 10.1 |
| 9.5 | 91.5 | 66.3 | 107.6 | 19.7 | 5.5 |

ND: values not determined because the extraction percentage was too low.
[Zr] = 3500-4000 mg/L; resin: Reillex ™ HPQ: m = 1 g; vol_{aq}= 10 mL; stirring = 10 min.; ambient temperature.

1.5. Description of a plant operating according to the principle of the invention

The mixture of zirconium and hafnium tetrachlorides in a ratio of 97.5/2.5, resulting from the initial carbochlorination of the mineral zircon, is dissolved in 9.5 N hydrochloric acid (this concentration is a good compromise between selectivity, S, and extraction capacity determined by means of the distribution coefficient D). This solution is introduced into a column containing a resin according to the invention, preconditioned with HCl. The hafnium is not retained by the resin and is therefore recovered at the column outlet (step 1). When the resin has become saturated with zirconium, it is washed with HCl (step 2), and the washing product is recovered for subsequent reprocessing as in step 1. The next step, 3 consists of washing with water, to release the zirconium and recover it. The column is then regenerated (step 4) and can be re-used, after a further conditioning with HCl.

It is to be understood that the invention defined by the attached claims is not limited to the particular embodiments indicated in the above description, but incorporates all the variants of the invention which do not depart from the scope or principle of the present invention.

1. Method for separating zirconium from hafnium in a mixture of ZrCl₄ and HfCl₄ containing 3% Hf by weight, expressed with respect to Zr+Hf, or less, the method comprising the following steps:
(1) hydrolysing the mixture of ZrCl₄ and HfCl₄ in an aqueous solution of a strong inorganic acid, to form an aqueous acid solution having 7 to 12 moles of acid per liter;
(2) passing the solution obtained in step (1) through an anion exchange resin;
(3) optionally, eluting a hafnium-enriched fraction of the solution obtained in step (1);
(4) removing an aqueous acid solution containing Zr and Hf from the resin; then
(5) passing an aqueous solution through the resin in order to release the zirconium compounds fixed to the resin, and recovering a zirconium-enriched fraction.

2. Method according to claim 1, wherein in step (2), the resin is conditioned in advance with a strong inorganic acid solution having from 7 to 12 moles of acid per liter.

3. Method according to claim 1, wherein the strong inorganic acid is selected from the group consisting of HCl and H₂SO₄.

4. Method according to claim 3, wherein the strong inorganic acid is HCl.

5. Method according to claim 1, wherein the aqueous acid solution has from 7.5 to 9.5 moles of acid per liter.

6. Method according to claim 1, wherein the anion exchange resin includes amine, ammonium or azine groups.

7. Method according to claim 1, wherein in step (5), the aqueous solution contains from 0 to 7 moles of acid per liter, and this molar concentration is less than the molar concentration of the inorganic acid solution used in step (1).

8. Method according to claim 7, wherein the aqueous solution is water.

9. Method according to claim 7, wherein step (5) further comprises passing at least one additional aqueous solution with a decreasing acid concentration through the resin in succession.

10. Method according to claim 9, wherein the last aqueous solution passed through the resin in step (5) is water.

11. Method according to claim 1, wherein in step (4), the resin is rinsed with a strong inorganic acid solution having from 7 to 12 moles of acid per liter, and having a number of moles of acid per liter substantially identical to or greater than the solution obtained in step (1).

12. Method according to claim 1, wherein, in step (4), the liquid content of the resin is removed.

13. Method according to claim 1, wherein the hafnium-enriched fraction is recovered in step (3).

14. Method according to claim 2, wherein the strong inorganic acid is selected from the group consisting of HCl and H₂SO₄.

15. Method according to claim 14, wherein the aqueous acid solution has from 7.5 to 9.5 moles of acid per liter.

16. Method according to claim 14, wherein the anion exchange resin includes amine, ammonium or azine groups.

17. Method according to claim 14, wherein in step (5), the aqueous solution contains from 0 to 7 moles of acid per liter, and this molar concentration is less than the molar concentration of the inorganic acid solution used in step (1).

18. Method according to claim 14, wherein in step (4), the resin is rinsed with a strong inorganic acid solution having from 7 to 12 moles of acid per liter, and having a number of moles of acid per liter substantially identical to or greater than the solution obtained in step (1).

19. Method according to claim 11, wherein in step (4), the liquid content of the resin is removed.

20. Method according to claim 14, wherein the hafnium-enriched fraction is recovered in step (3).
